(19) United States
(12) Patent Application Publication
(10) Pub. No.: US 2008/0150204 A1
(43) Pub. Date: Jun. 26, 2008

(54) Stabilizer for vibration isolation platform

(75) Inventors: Alex klooster, Ann Arbor, MI (US); Michael Mater, Chelsea, MI (US)

Correspondence Address: Rodney T. Hodgson, Ph.D., 8986 Shenendoah Circle, Naples, FL, 34113, US

(73) Assignee: Coherix, Inc, Ann Arbor,, MI (US)

(21) Appl. No.: 11/933,558

(22) Filed: Nov. 1, 2007

Related U.S. Application Data
(60) Provisional application No. 60/871,472, filed on Dec. 22, 2006.

(51) Int. Cl. F16F 7/00

(52) U.S. Cl. 267/140.11

(57) ABSTRACT

A vibration isolation platform having supports such as air pistons to damp out low frequency vibrations is equipped with a means for restricting pitch and roll motion as the weight distribution is changed and the vibration isolation platform exhibits vertical motion. The preferred means for restricting are torsion bars and tension means which transfer force from one part of the platform to the other.

### CROSS REFERENCE TO RELATED APPLICATIONS

This application claims priority pursuant to 35 U.S.C. 119(e) to U.S. Provisional Application No. 60/871472 filed 19 Jan. 2007, which application is incorporated herein by reference in its entirety including incorporated material.

### RELATED PATENTS AND APPLICATIONS

U.S. Pat. No. 5,907,404 by Marron, et al. entitled “Multiple wavelength image plane interferometry” issued May 25, 1999;

U.S. Pat. No. 5,926,277 by Marron, et al. entitled “Method and apparatus for three-dimensional imaging using laser illumination interferometry” issued Jul. 20, 1999;

U.S. patent application Ser. No. 10/893,052 filed Jul. 16, 2004 entitled “Object imaging system using changing frequency interferometry method” by Michael Mater;

U.S. patent application Ser. No. 10/349,651 filed Jan. 23, 2003 entitled “Interferometry method based on changing frequency” by Michael Mater;

U.S. patent application Ser. No. 11/181,664 filed Jul. 14, 2005 by inventors Jon Nisper, Mike Mater, Alex Klooster, Zhenhua Huang entitled “A method of combining holograms”;

U.S. patent application Ser. No. 11/194,097 filed Jul. 29, 2005 by inventor Mike Mater et. al entitled “Method for processing multiwavelength interferometric imaging data”.

U.S. patent application Ser. No. 11/194,092 filed Jul. 29, 2005 by inventor Mike Mater et. al entitled “A statistical method of generating a synthetic hologram from measured data”.

U.S. patent application Ser. No. 11/194,103 filed Jul. 29, 2005 by inventor Michel Mater et. al entitled “Method for processing multiwavelength interferometric imaging data”.

A U.S. patent application Ser. No. 11/301,320 entitled “Optical fiber delivered reference beam for interferometric imaging” filed Dec. 12, 2005.

A U.S. patent application Ser. No. 11/299,548 entitled “Optical fiber delivered reference beam for interferometric imaging” filed Dec. 12, 2005.

A U.S. patent provisional application 60/868,120 filed Dec. 1, 2006.

A U.S. patent provisional application 60/868,547 filed Dec. 5, 2006.

A U.S. patent provisional application 60/868,734 filed Dec. 6, 2006.

A U.S. patent provisional application 60/946772 filed 6 Jul. 2007.

A U.S. patent provisional application 60/946610 filed 12 Jul., 2007.

A U.S. patent provisional application 60946629 filed 27 Jun., 2007.

The above identified patents and patent applications are assigned to the assignee of the present invention and are incorporated herein by reference in their entirety including incorporated material.

### FIELD OF THE INVENTION

The field of the invention is the field of vibration isolation and stabilization of mechanically supported objects.

### OBJECTS OF THE INVENTION

It is an object of the invention to produce a stabilized vibration isolation platform which does not roll or pitch if additional weight is added to or removed from the platform.

### SUMMARY OF THE INVENTION

In a first embodiment, a plurality of tension elements is attached to a platform, wherein each of the plurality of tension elements such as cables pulls the platform in approximately the same direction as the gravitational pull on the platform. The platform is supported against the pull of gravity and the tension of the cables by one or more non-rigid or compliant supports such as pressurized pistons, air bags, or elastomeric elements which change dimensions to support more or less force from the platform as weight is added to the platform. Each tension element is attached at one point to a tension producing device pulling at the tension elements, so that the tension producing device produces a tension force equal to the sum of the tensions forces of the plurality of tension elements. In a second embodiment, a torsion device transfers vertical force from one part of the platform to another to keep the table from pitching or rolling as the load on the table is changed.

### BRIEF DESCRIPTION OF THE DRAWINGS

FIG. 1 is a sketch of an embodiment of the invention.

FIG. 2 is a sketch of an embodiment of the invention.

FIG. 3 is a sketch of an embodiment of the invention.

FIG. 4 is a sketch of plan view of an embodiment of the invention shown in FIG. 3.

FIG. 5 is a sketch of an embodiment of the invention.

FIG. 6 is a sketch of plan view of an embodiment of the invention shown in FIG. 5.

FIG. 7 is a sketch of an embodiment of the invention.

### DETAILED DESCRIPTION OF THE INVENTION

It is common to mount sensitive optical and other equipment on vibration isolation tables to isolate the equipment from vibrations transmitted through the ground or the base of the table, or to damp out vibrations transmitted through the air to the equipment.

Vibration isolation tables are effective at damping out high frequency vibrations, but low frequency vibrations are often reduced by mounting the table on air pistons, so that air pressure in the pistons holds the table up, and low frequency vibrations are not transmitted effectively through the air.

The pistons are usually attached to a source of pressurized air, and a feedback mechanism is used to discharge or introduce air out and into the piston. When a weight is added to the table, the table will pitch and/or roll and the feedback system adjusts the air pressures to bring back the table to the set position. The set position is usually to have the table surface level, but this is not necessary for the operation of the present invention.

Unfortunately, the time taken for the stabilization of the system is of the order of tens of seconds. For measurements which must be made on objects which are added and then removed from the table, and which must be made in tens of seconds, this time is too long. The present invention shows a number of embodiments which stabilize the table in pitch and roll, and control “rocking” motions which affect heavy optical or other apparatus mounted with center of gravity high above the table. The vertical motion of the table is not restricted, and the table moves vertically as weight is added or subtracted.

FIG. 1 shows a sketch of a preferred embodiment of the invention. A stabilized vibration isolation platform 10 is supported against gravity by one or more supports 11. In the most preferred embodiments of the invention, the mounts are pistons filled with a gas such as compressed air, but could be pistons filled with any compressible fluid in fluid communication with a device to set and regulate pressure. In other embodiments, the supports 11 are elastomeric elements, compressible fluid filled elements or other elements for which force supporting the platform is changed as weight is added or subtracted from the table and the dimensions of the element change. The platform is attached by cables 12 at points 13. Tension is applied to the cables by attaching the cables to or near to the same point 14 of a tension producing device 15. In FIG. 1, a weight is shown providing the tension. The tension forces transmitted through the cables 12 are changed in direction by pulleys 16. The angle formed by the two cables 12 at attachment point 14 is exaggerated in FIG. 1 for clarity, and the respective pulleys 16 should be as close together as possible. A turnbuckle 17 is used to adjust the relative lengths of the cables to change the relative tension in cables ensure, for example, that the platform 10 is level.

In operation, the platform is set to a particular position by adjusting the supports 11 and/or the turnbuckle 17. When a weight is added off center to the platform, the added weight depresses the support 11 on one side of the platform and reduces the tension of one of the cables 12. The entire tension from the tension producing device 15 is now transmitted to the other of cables 12, and the increased tension depresses the other side of the platform against the other support 11, so the platform sinks and the relative heights of the attachment points 13 changes little, so that the table 10 remains level.

In a feedback mode, the air pressure in supports 11 will be changed to increase the pressure, and move the platform back to its original position. If supports 11 are elastomeric elements, the increased weight will compress the elements until the added weight is compensated, and the platform motion will stop with the platform at a lower position than the original position. In both cases, the tensions in the cables 12 will be different from the original tensions, but the tensions in each cable will sum to the force produced by the tension producing device 15.

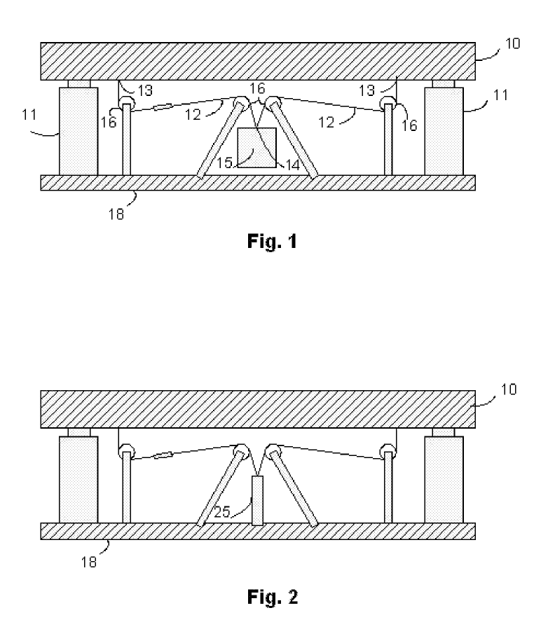

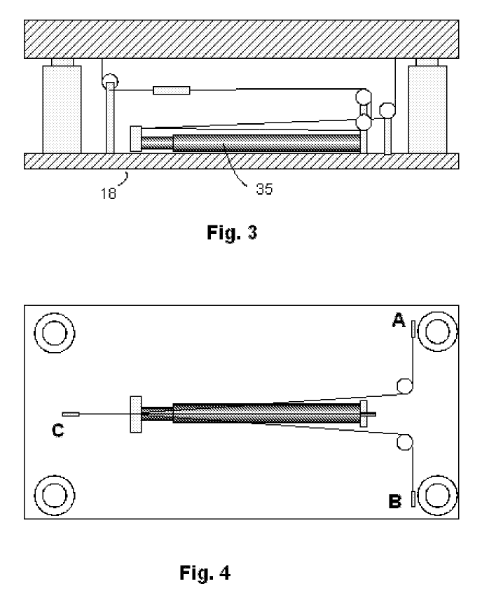

A preferred device 15 of the invention is a spring 25 attached between the cables 15 and a stable point such as the floor, the ground, or a base 18, as shown in FIG. 2.

Other preferred embodiments of the invention include a pneumatically operated piston 35 which is controlled to adjust the height of the platform 10.

In all cases, the supports 11 supporting the platform must offer sufficient support for the weight of the platform and the weights which the platform will carry, as well as the tension forces of the cable 12. Clearly, the pressure in supports 11 can be different, as can the tensions in cables 12, and the balance of the support forces and the tension forces can be set to adjust the position of the platform within wide limits.

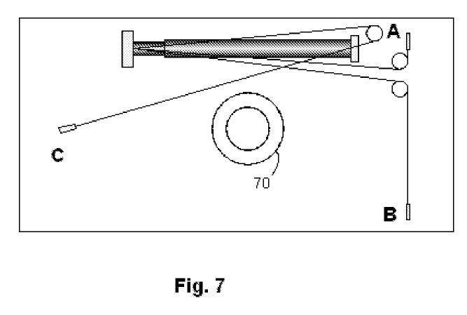

In the prior art, a number three or more of supports 11 would normally be used to support the platform. A feedback mechanism would normally be used to raise and lower pressure in each support until each support drives the table to a predetermined height at the position of the support, so that the entire table is level. Note that controllers, feedback electronics, and separate valves for each support are needed. In the present invention, a single support 70 is sufficient, as is shown by FIG. 7. The level of the platform 10 is then determined only by the balance of tensions in the cables 12. In addition, if a number of supports 11 are used, a single air supply can feed each support, so the air pressure in each piston is equal, and the differing tensions in the cables 12 compensate for the differing weight distributions of the objects loaded on the table. The cost of the cables and pulleys and weights or torsion bars is expected to be less that the costs of the extra apparatus needed in the prior art.

While cables are shown as the tension elements in FIGS. 1-3, other tension elements such as chains, short segments of rod, etc, are anticipated by the inventors as parts of a system to transmit tensile forces to the platform 10.

In addition, vibration damping elements (not shown) may be added to the various springs, weights, pistons, and supports.

While FIGS. 1-3 show a side elevation of a platform with two cables which stabilize the platform from rotating about one axis parallel to the top of the platform, addition of a third cable will provide stabilizing the platform about a second axis parallel to the top of the platform, as is shown in FIG. 4. Obviously, more than 3 cables may be provided for more control and security.

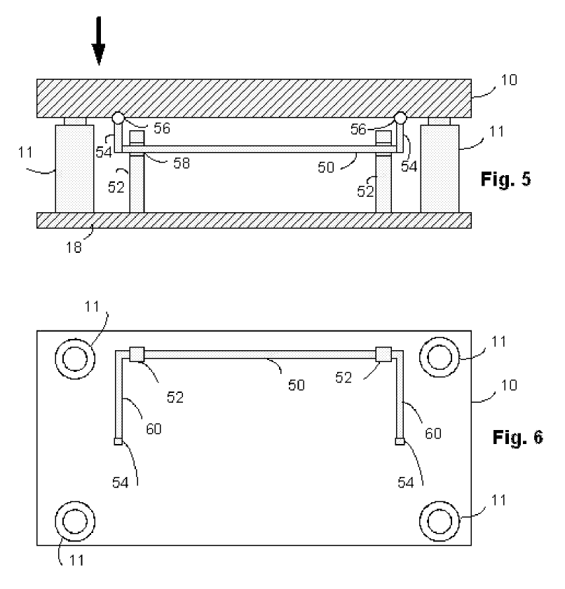

FIGS. 5 and 6 show the most preferred embodiment of the invention. A torsion bar 50 runs through torsion bar supports 52 to an arm 60, which connects in turn to a member 54 attached to the table 10. Devices 56 such as ball joints which allow member 54 to rotate slightly with respect to table 10, and bearings 58, ensure that the vertical motion of the table pressing down one member 54 is smoothly transmitted to the other member 54 to pull down the table by an equal amount, so that the table remains level.

While FIGS. 5 and 6 show for simplicity only one torsion bar for stabilizing the table in one rotational axis, clearly a second torsion bar can be added at an angle to the first to ensure that the table remains level whenever a load is placed.

In the preferred embodiments of the invention, the table 10 floats freely on the supports 11, and low frequency vibrations are not transmitted from the ground or from the base 18 to the ground. As objects are loaded or unloaded from the table 10, that table may move vertically, but is prevented from rolling or pitching. (Yaw is a rotation around the vertical axis, and is not treated herein.) Limiting means (not shown) may be used to limit the vertical excursion of the table so that the table may return quickly to the equilibrium height as one weight is replaced by an equal weight. Alternatively, or in addition, the feedback system regulating the air pressure in the support members 11 may be turned off as the weights are removed and replaced, so that the table returns quickly to the equilibrium position.

Obviously, many modifications and variations of the present invention are possible in light of the above teachings. It is therefore to be understood that, within the scope of the appended claims, the invention may be practiced otherwise than as specifically described.

We claim:

1. An apparatus, comprising:
a) a vibration isolation platform for supporting objects, wherein the vibration isolation platform is supported against gravity by at least one vibration damping support member, wherein the at least one vibration damping support member allows vertical motion of the vibration isolation platform as objects are removed and added to the vibration isolation platform; and
b) means for restricting rotational motion of the vibration isolation platform as the distribution of weight on the vibration isolation platform is changed and the vibration isolation platform exhibits vertical motion.

2. The apparatus of claim 1, wherein the means for restricting is at least one torsion bar.

3. The apparatus of claim 1, wherein the means for restricting are tension elements.

4. An apparatus, comprising:
a) a vibration isolation platform for holding objects;
b) a plurality of tension members attached in tensile attachment to the vibration isolation platform at a plurality of points;
c) at least one supporting member supporting the vibration isolation platform against gravity and against tension produced by the tension members;
d) a tension producing device attached in tensile attachment to each of the plurality of tension members, wherein each of the plurality of tension members is attached in tensile attachment to the same attachment point of the tension producing device.

5. The apparatus of claim 4, wherein the tension producing device is a spring.

6. The apparatus of claim 5, wherein the spring is attached to a base, the base supporting the at least one supporting member.

7. The apparatus of claim 6, wherein the spring is attached to the base through a damping element.

8. The apparatus of claim 4, wherein the at tension producing device is a pressurized tension producing member attached to a base, the base supporting the at least one supporting member.

9. The apparatus of claim 8, wherein the pressurized tension member is attached to the base through a damping element.

10. The apparatus of claim 4, wherein the tension producing device is an elastomeric element attached to a base, the base supporting the at least one supporting member.

11. The apparatus of claim 4, wherein the elastomeric element is attached to the base through a damping element.

12. The apparatus of claim 4, wherein the tension producing device is a weight.

13. The apparatus of claim 4, wherein the at least one supporting member is a pressurized support member.

14. The apparatus of claim 14, wherein pressure in the at least one supporting member is automatically changed to return the vibration isolation platform to a starting position after a weight is added to the vibration isolation platform.

15. The apparatus of claim 4, wherein the at least one supporting member is an elastomeric element.

16. An apparatus, comprising:
a) a vibration isolation platform for holding objects;
b) a plurality of tension members attached in tensile attachment to the vibration isolation platform at a plurality of points;
c) at least one supporting member supporting the vibration isolation platform against gravity and against tensile forces produced by the plurality of tension members, the at least one supporting member supporting the vibration isolation platform with compressive fluid forces;
d) a tension producing device attached in tensile attachment to each of the plurality of tension members, wherein the tension in the main tension member is the sum of the tension forces of the plurality of tension members.
